(19) United States
(12) Patent Application Publication
(10) Pub. No.: US 2006/0245738 A1
(43) Pub. Date: Nov. 2, 2006

(54) Network streaming control methods

(75) Inventor: Chang-Hung Lee, Yunlin (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/413,170

(22) Filed: Apr. 28, 2006

(30) Foreign Application Priority Data
Apr. 28, 2005 (TW) 94113655

(51) Int. Cl. H04N 7/26

(52) U.S. Cl. 386/112

(57) ABSTRACT

A method and a system of controlling streaming data in a network. The system includes an receiver and a data transmitter. The receiver has a video player. The receiver receives an encoded signal from the data transmitter via the network, and displays the encoded signal on the video player, wherein the encoded signal has a f1irst operating mode. The method comprises receiving a command, generating a second operating mode according to the command and the first operating mode, displaying the second operation mode, transmitting the command to a data transmitter via the network, and transmitting the encoded signal within the second operating mode to the receiver via the network.

### BACKGROUND

The invention relates to network application, and more particularly, to display transmitting data status in wireless networks.

As broadband networks grow, multimedia applications have become a major part of the consumer market. Multimedia based on broadband audio/video (AV) provides versatile service. FIG. 1 shows a system of transmitting streaming data via a network. A television signal is received by tuner 112, and sent to data transmitter 114. The signal is encoded and transmitted via WAN/LAN (wide area network/local area network) 116, and received by an AV player 118, such as a television. With development of wireless networking and broadband transmission techniques, separate television and TV tuner can easily transmit and receive AV data through a network.

However, protocol problems still exist when transmitting AV data through a network. Typically, the IP address or status of data transmitter 114 may not be known. Control of AV player 118 provides only indirect management received data, whereby AV player 118 transmits a command to data transmitter 114 and tuner 112. The command may be missed or delayed in the network. FIG. 2 shows a conventional method of controlling streaming AV data, in which, in an initial state A0, a receiver is tuned channel 42. To change the channel, a command is sent to the AV receiver, in step A1, through the AV player 118, which transmits a “channel up” command to the data transmitter, in step A2. The data transmitter 114 receives the command, and re-configures the tuner 112. The tuner 112 tunes to channel 43 in step A3. Because of network delay, the user may assume that the command has not been sent and re-enter the command, in step A4. The tuner 112 has already acquired the data stream of channel 43 and transmitted to the data transmitter 114, in step A5. The second user command is sent to the data transmitter 114 in step A6 which has already send data stream of channel 43 to the AV player 118 in step A7 and, having received the second command, re-configures the tuner 112. The tuner 112 tunes to channel 44, in step A8. The data stream of channel 43 arrives and is displayed on AV player 118, in step A10, but the data transmitter then sends data stream of channel 44 to the AV player 118, in step A11. Channel 43 is shown briefly and then replaced by channel 44 data stream, in step A12.

The conventional communicating method acts only on communication between television and built-in tuner. Thus, control of separate tuner and television may result in delays or missed commands during transmission.

### SUMMARY

The invention is directed to communication involving a tuner, a data transmitter, receiver, and a television. The invention provides a method of controlling streaming data in a network. Audio or video data encoded streaming data has a first operating mode. Upon receipt of encoded streaming data from an AV transmitter via the network, the AV player displays the AV encoded streaming data. The method comprises receiving a command, generating a second operating mode according to the command and the first operating mode, displaying the second operating mode, transmitting the command to a data transmitter via the network, and transmitting the AV encoded streaming data to the AV player via the network.

The invention further provides a system for transmitting and receiving streaming data. The system comprises a transmitter and a media player, a video player. The transmitter comprises a first control unit, transmitting encoded streaming data in a first operating mode. The video player comprises a display unit, an decoder, and a second control unit. The decoder decodes the encoded signal to a display signal, for display on the video player. The second control unit receives a command and transmits the command to the first control unit via the network. The first control unit converts the encoded signal to a second operating mode, and when the second control unit receives the command, the display unit displays the second operating mode.

### BRIEF DESCRIPTION OF THE DRAWINGS

Systems and methods can be more fully understood by reading the subsequent detailed description and examples of embodiments thereof with reference made to the accompanying drawings, wherein:

FIG. 1 shows a system of transmitting streaming data in a wireless network;

FIG. 2 shows a conventional method of controlling streaming AV data;

FIG. 3 shows a method of transmitting streaming data according an embodiment of the invention; and

FIGS. 4a and 4b show a system of transmitting streaming data according to an embodiment of the invention.

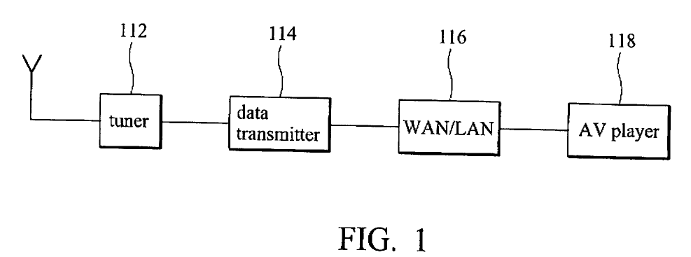

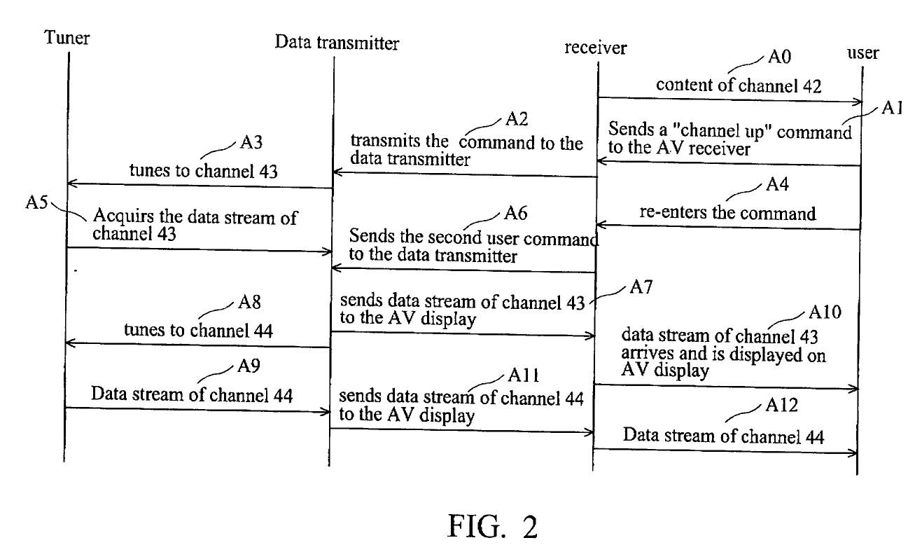

### DETAILED DESCRIPTION

Embodiments of the invention provide a method and system for transmitting streaming data in a network.

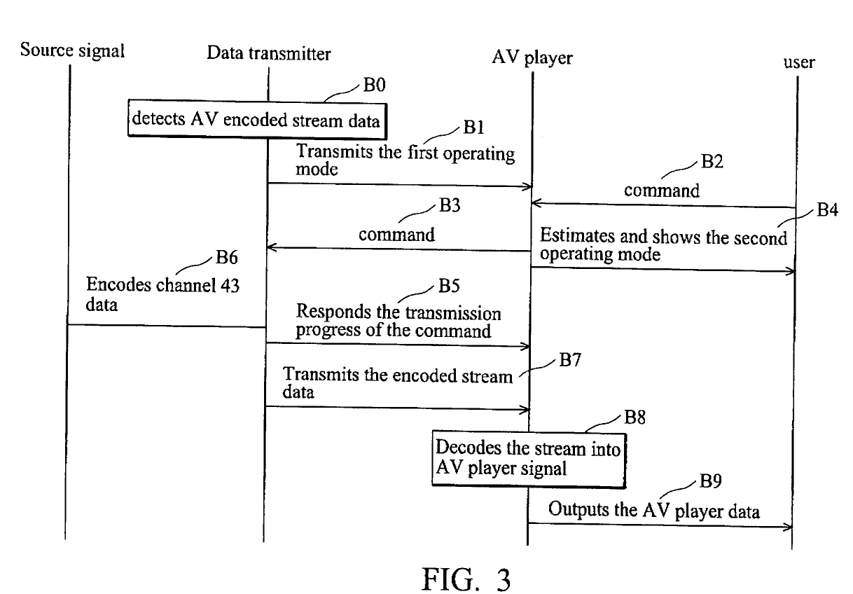

FIG. 3 shows a method of transmitting streaming data according to an embodiment of the invention. The data transmitter detects an operating mode of encoded streaming data, and sets the operating mode as a first operating mode, in step B0. In step B1, when the AV player is activated, the data transmitter transmits a first operating mode to the AV player, and an OSD (on-screen display) module of the AV player shows the first operating mode. When an AV player, such as television, is activated, the AV player shows, for example, content of channel 42. The AV player receives a command to change channels, in step B2. The command is sent to the data transmitter, in step B3. Concurrently, the AV player estimates a second operating mode according to the command and the first operating mode, and shows the second operating mode on the OSD, in step B4. The AV player immediately provides notification that the command has been received, preventing repeat command input. In this embodiment of the invention, the AV player shows “channel 43” or a blank display as notification that the command has been sent. In step B3, the command is transmitted through TCP/IP (Transmission Control Protocol/Internet Protocol) which controls traffic, confirms packet transmission, and re-transmits failed transmission. Transmission progress is provided to the AV player, in step B5. The data transmitter receives another source signal according to the command. In this embodiment of the invention, the source signal is from a tuner. The tuner tunes to the selected channel, and transmits the data stream of channel 43 to the data transmitter. The data transmitter receives channel 43, replacing channel 42. The data transmitter encodes channel 43 data to an encoded signal or an encoded data stream, in step B6. The data transmitter then transmits the encoded streaming data to the AV player through TCP/IP, or other equivalent protocol, in step B7. Upon receipt of the encoded streaming data from the network, the AV player decodes the stream into a display signal, in step B8. In step B9, the AV player outputs the display signal.

In other embodiments of the invention, the source signal can be from a DVD player or other medium. When the DVD player and AV player are separate, the DVD contents can be sent to the data transmitter, then to the AV player. To adjust received DVD data, such as changing track or chapter, forward, pause, reverse or adjust volume, commands are input directly to the AV player. Transmission of commands and receiving of confirmation are the same as FIG. 3.

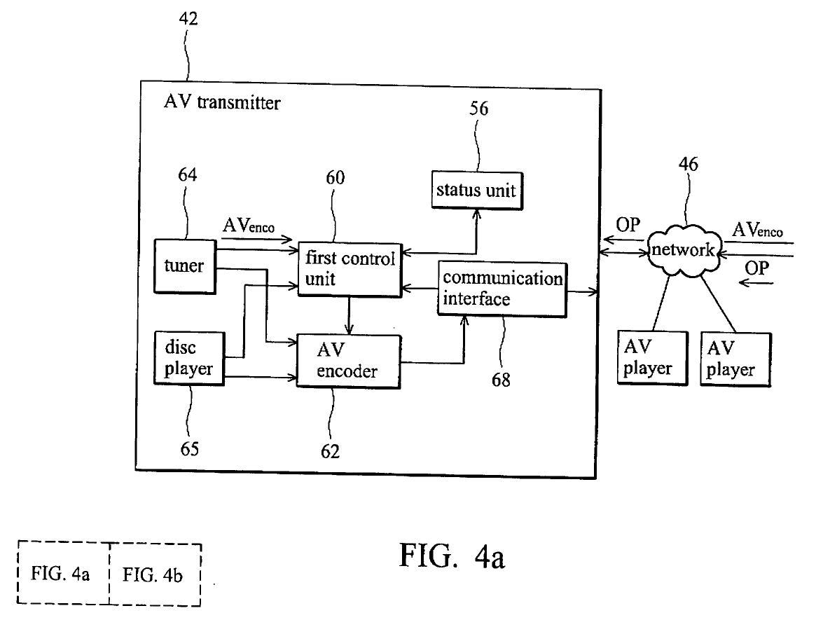

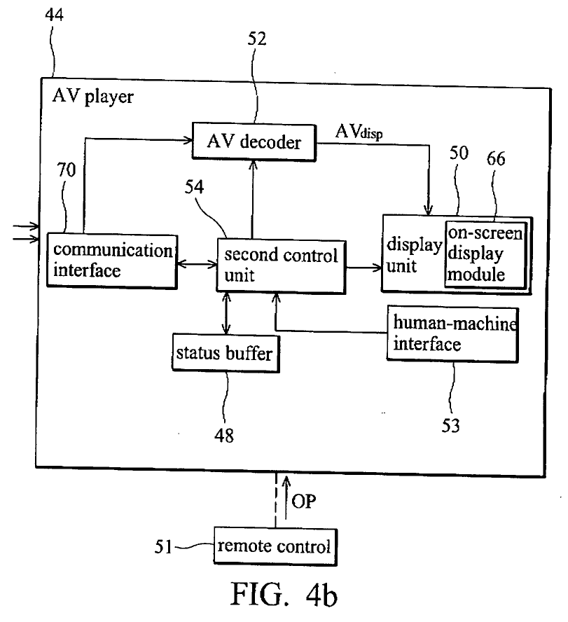

FIG. 4a, 4b show a data streaming system according to an embodiment of the invention, comprising a data transmitter 42 and an AV player 44.

In this embodiment, a tuner 64 or disc player 65 provides a source signal. When the signal is originated with the tuner 64, the operating mode is the channel number to which the tuner 64 is set. When the source signal is originated with the disc player 65, the operating mode is track or chapter change, forward, pause, review, or adjustment volume, or others.

The data transmitter 42 further comprises a status unit 56, an AV encoder 62, a first control unit 60, and a communication interface 68. The status unit 56 detects and stores the operating mode. For example, when the source signal is from the tuner 64, and the display is set to channel 42, operating mode is “receiving channel 42”. If the data transmitter 42 is turned off, when the data transmitter is restarted, the display is still set to channel 42. The AV encoder 62 encodes the source signal to encoded signal AV_{enco}, which is then transmitted through the first control unit 60.

The AV player 44 receives the encoded signal AV_{enco} via the network 46. The AV player 44 comprises a communication interface 70, a display unit 50, an AV decoder 52, a status buffer 48, and a second control unit 54. The AV decoder 52 decodes the encoded signal AV_{enco} from communication interface to an AV player signal AV_{disp}. The display unit displays the AV player signal AV_{disp}. The second control unit 54 receives a command OP, and directs an on-screen display module 66 of the display unit 50 to display the operating mode, and informs the status buffer 48 to store the current operating mode. The command OP is also transmitted to the first control unit 60, so that the first control unit 60 changes the operating mode of the encoded signal AV_{enco}.

For example, a command to display data display 44, when current display is channel 42, is input to the AV player 44. The second control unit 54 transmits the command to the data transmitter 42, which then data transmitter 42 receives the signal of channel 43 and the data transmitter 42 transmits a “channel 43 is selected” message to the second control unit 54. When the AV player 44 receives the encoded signal AV_{enco} of channel 43, the AV decoder 56 decodes the encoded signal AV_{enco}, and sends the decoded signal to the display unit 50. The status buffer 48 also records that the current channel is 43.

In another embodiment of the invention, the second control unit 54 also transmits the operating mode to the AV decoder 52. The AV decoder 52 integrates the operating mode into the AV player signal AV_{disp}, such that both data and operating mode, here the number “42”, are displayed.

In another embodiment of the invention, the AV player 44 further comprises a human-machine interface 53. The human-machine interface 53 receives the command to the AV player 42. In addition, the system also comprises a remote control 51, commanding the AV player 42.

In another embodiment of the invention, the data transmitter 42 and the AV player further comprise communication interfaces 68, 70, respectively, and commands are transmitted through TCP/IP.

TCP/IP transmission allows the system to respond to all commands instantaneously. Transmission control is thus more precise. Further, the AV player provides instant notification of command status. The data transmitter communicates with the AV player through TCP/IP, providing more effective control.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of controlling data streaming for a video player, the video player receiving an encoded signal from a transmitter via the network, the video player displaying the encoded signal, and the encoded signal has a first operating mode, the method comprising:
receiving a command;
generating a second operating mode according the command and the first operating mode;
displaying the second operation mode;
transmitting the command to the transmitter via the network; and
receiving the encoded signal within the second operation mode from the transmitter.

2. The method as claimed in claim 1, wherein the command are transmitted and received using TCP/IP.

3. The method as claimed in claim 1, further comprising:
connecting the video player and the transmitter via the network; and
transmitting the first operating mode to the video player and storing the first operation mode in the video player.

4. The method as claimed in claim 3, further comprising:
activating the video player; and
detecting the operating mode of the encoded signal by the transmitter, and setting the operating mode as the first operating mode.

5. The method as claimed in claim 1, further comprising receiving a source signal, and encoding the source signal into the encoded signal.

6. The method as claimed in claim 5, wherein the source signal comes from a tuner, and the first operating mode is corresponding to a channel number of the tuner.

7. The method as claimed in claim 5, wherein the source signal comes from a disc player, and the operating mode is one mode of track or chapter change, forward, pause, review and volume adjustment.

8. The method as claimed in claim 1, wherein the video player inserts the second operating mode into the encoded signal for displaying on the video player.

9. The method as claimed in claim 1, wherein the video player comprises a human-machine interface for receiving the command.

10. A system for transmitting and receiving data, comprising:
a transmitter having a first control unit, the transmitter transmitting an encoded signal within a first operation mode;
a receiver for receiving the encoded signal via a network, the receiver comprising:
a display unit;
a decoder for decoding the encoded signal to a display signal and displayed the display signal on the video player; and
a second control unit, receiving a command and transmitting the command to the first control unit through the network, the first control unit changing the encoded signal to the second operating mode according to the command, and the second control unit generating the second operating mode according the command and the first operating mode and the display unit displaying the second operation mode.

11. The system as claimed in claim 10, wherein the transmitter and the receiver further comprise a communication interface, and the command is transmitted and received via TCP/IP.

12. The system as claimed in claim 10, the receiver further comprising:
a status buffer, storing the first operating mode; wherein the second control unit generates the second operating mode according to the first operating mode and the command.

13. The system as claimed in claim 12, wherein upon connection of the receiver with the data transmitter, the transmitter transmits the first operating mode of the encoded signal to the receiver.

14. The system as claimed in claim 13, the transmitter further comprising:
a status unit, storing the first operating mode, wherein the transmitter detects an operating mode of the encoded signal and set the detected operating mode as the first operating mode when the transmitter is activated.

15. The system as claimed in claim 10, the data transmitter further comprising:
an encoder, receiving a source signal, and the encoder encoding the source signal to the encoded signal.

16. The system as claimed in claim 15, wherein the source signal comes form a tuner, and the first operating mode is a channel number of the tuner.

17. The system as claimed in claim 15, wherein the source signal comes from a disc player, and the first operating mode is one of track or chapter change, forward, pause, review and volume adjustment.

18. The system as claimed in claim 10, the display unit further comprising a on-screen display (OSD) module, wherein the second control unit transmits the second operating mode to the OSD module, and the OSD module displays the second operating mode.

19. The system as claimed in claim 10, wherein the second control unit transmits the second operating mode to the decoder, and the decoder inserts the second operating mode into the display signal.

20. The system as claimed in claim 10, the receiver further comprising:
a human-machine interface, receiving the command to the display.
